(19) United States
(12) Patent Application Publication
(10) Pub. No.: US 2009/0024359 A1
(43) Pub. Date: Jan. 22, 2009

(54) Portable modular industrial data collector and analyzer system

(75) Inventors: David J. Bibelhausen, Maineville, OH (US); Donn V. Stoutenburg, Westerville, OH (US)

Correspondence Address: Fletcher Yoder Law;(for Rockwell Automation), P. O. Box 692289, Houston, TX, 77269-2289, US

(73) Assignee: Rockwell Automation Technologies, Inc.

(21) Appl. No.: 11/879,183

(22) Filed: Jul. 16, 2007

(51) Int. Cl. G06F 15/00

(52) U.S. Cl. 702/188

(57) ABSTRACT

A multi-unit system is disclosed that is configured for hands-free transport to enable remote data collection and data processing for a complex machine system or plethora of rotating machinery. In one embodiment, the system may include a sensor, a portable processing unit, and a hand-held unit that is physically separate from but in data communications with the portable processing unit. The hand-held unit may include a display and a user interface. The portable processing unit may include a processor that is configured to communicate with a sensor that is configured to detect a dynamic operating condition of a machine system. Additionally, the hand-held unit may communicate directly with the sensor. The communication links between the portable processing unit and the sensor; between the hand-held unit and the portable processing unit; and between the hand-held unit and the sensor may be either a wireless connection or a wired connection.

### BACKGROUND

The invention relates generally to the field of monitoring and protection systems of the type used in industrial and other settings. More particularly, the invention relates to a novel topology that provides for a portable modular industrial data collector and analyzer system

Monitoring systems are ubiquitous through a range of industrial settings. In many machine applications, for example, dynamic operating conditions of equipment are monitored to determine the proper operating state, to forecast and avoid problems and breakdowns, and so forth. Such systems are also used to control processes, and to monitor conditions of equipment that may evolve over time. In large machine settings, specific monitors may be provided at locations adjacent to points in the machine system where dynamic conditions are to be detected and monitored. The monitoring equipment at each location is typically connected to associated sensors or transducers that generate signals representative of the conditions of interest. Monitors within an enclosure at the locations may communicate with one another via a backplane and may be equipped to communicate with other modules in the machine system or with remote equipment.

Where a large number of sensors or transducers are employed at various machine locations, wiring can become extremely cumbersome. In particular, each transducer or sensor is generally linked to the local monitors via dedicated wires or cables. Where monitors are linked in series or grouped in networks around the machine system, bundles of wires or harnesses may be required between the various locations. Moreover, where monitors at different machine locations are linked to central monitoring stations, as is typical in many industrial processes, additional separate cabling or cable harnesses must be provided between the groups of modules and the central monitoring station. Given these needs and their consequent costs, many points in machine systems and factories that could be monitored simply go uninstrumented, or may be monitored periodically by technician “walk arounds.”

Additionally, plant floor inspection and investigation may be required to monitor some points in the system and to troubleshoot suspected problems within a large or complex machine. This can involve a labor intensive process that requires a technician to physically locate the respective transducer, and related wiring, in order to collect the desired data. After collecting the data, the technician may then be required to move to another location to evaluate and process the data before returning to the machine to correlate the processed data to physical observations. Moreover, this troubleshooting process may be further complicated by an intermittent machine problem that does not occur during both the data collection and post-processing observation phase.

A current approach to monitoring points of a machine system that are not already instrumented, for example, entails a technician placing a sensor assembly (e.g., including an accelerometer for vibration measurements) at a point to be monitored. The sensor assembly is tethered to a hand-held collection device carried by the technician. This process can be quite time consuming and tedious for the technician, particularly given the size and weight of current sensor assemblies and collection devices.

There is a need, therefore, for an improved system topology for use in dynamic condition monitoring applications. There is a particular need for a system that enables an operator to more easily collect and analyze vibration and other condition data for a complex or large machine system. Additionally, there is a need for a data collector and analyzer system that is readily portable or ambulatory and reduces operator fatigue during use and/or transport. Finally, there is a need for a portable system that is configured to communicate with monitoring assemblies, hosts, central monitoring stations, remote monitoring stations, and/or other devices used to monitor a complex or large machine system; or a plethora or sets of machinery.

### BRIEF DESCRIPTION

Embodiments of the present invention enable easy transport of a multi-unit portable modular industrial data collector and analyzer system. The system may replace existing ambulatory or “walk around” data collectors, and function with existing sensors, transducers, local monitoring modules and assemblies, and so forth. The system allows for the retrieval and storage of data for contemporaneous or subsequent analysis. That is, where desired, the collected data may be simply stored or partially processed for later transfer (e.g., uploading) to other analysis or storage systems. However, the system may also be programmed with the capability for immediate analysis as an analyzer when a technician is on site at a machine location. The system also permits data to be stored and analyzed locally, such as to identify trends in operation of machines as indicated by the collected data for real and non-real-time analysis or tending.

For example, the system may include a sensor, a portable processing unit, and a hand-held unit that is physically separate from but in data communications with the portable processing unit. The hand-held unit may include a display and a user interface that may include a keypad, a touch screen, a pointing device, a touch pad, a track ball, a pointing stick, a graphics tablet, a keyboard or any other suitable user interface. Further, the portable processing unit may include a processor that is configured to communicate with a sensor that detects a dynamic operating condition of a machine system. Additionally, the hand-held unit may communicate directly with the sensor as well. The communication links between the portable processing unit and the sensor, between the hand-held unit and the portable processing unit, and between the hand-held unit and the sensor may be either a wireless connection or a wired connection. The wireless communication may be made via infrared, radio frequency, or any other suitable wireless link. Wired communication links may include communication cable, a universal serial bus, a PC card, a serial port, a parallel port, or any other sutiable wired link.

Additionally, the portable processing unit and hand-held unit may include a user mount to enable hands-free transport. The user mount may be a shoulder sling, a belt, a pouch, a plurality of straps, hook and loop fasteners, a pocket clip, or any other suitable arrangement for allowing comfortable transport. Further, the hand-held unit may be secured to the portable processing unit to simplify transport. The hand-held unit may include a personal digital assistant or other portable device that includes a display. This component may be a commercial “off-the-shelf” device properly configured to communicate with the processing unit. In fact, one or both of the processing unit and the hand-held unit may be programmed for some or all of the data analysis and storage desired of the system. The portable processing unit may include a portable computer, application specific computer, or any other suitable computing device. Also, the system may include a peripheral device, such as a head set, configured to communicate with the hand-held unit via a wireless communication link.

Another embodiment of the system may include an acquisition unit, and a portable unit that is physically separate from but in communications with the acquisition unit. The acquisition unit may include a processor that is configured to communicate with a plurality of sensors. The communication links between the acquisition unit, the portable unit, and the plurality of sensors enable an operator to process and analyze data generated by the sensors. The communications links may be wired connections and/or wireless connections. Additionally, the system may include a central monitoring station configured to communicate with the acquisition unit, the portable unit, a plurality of sensors, or a combination thereof. Finally, the acquisition unit and the portable unit may include structures that enable hands-free transport of the units.

In a further embodiment, the system may include an ambultory processing unit that is physically separate from but in communications with the display unit. The ambultory processing unit and/or the display unit are configured to communicate with a plurality of sensors enabling an operator to collect and analyze data generated by the plurality of sensors. The communications links between the processing unit and the display unit, as well as between either of these and the sensors may be wired and/or wireless.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a portable modular industrial data collector and analyzer system that includes a hand-held unit that is physically separate from, but in communication with a portable processing unit;

FIG. 2A is diagrammatical representation of exemplary functional components that may be included in the hand-held unit of FIG. 1;

FIG. 2B is diagrammatical representation of exemplary functional components that may be included in the portable processing unit of FIG. 1;

FIG. 3 is a diagrammatical overview of a machine system employing the portable modular industrial data collector and analyzer system in accordance with aspects of the present technique;

FIG. 4A illustrates an exemplary communication configuration between the hand-held unit, the portable processing unit, and a sensor;

FIG. 4B illustrates a second exemplary communication configuration between the hand-held unit, the portable processing unit, and a sensor;

FIG. 4C illustrates a third exemplary communication configuration between the hand-held unit, the portable processing unit, and a sensor;

FIG. 4D illustrates a fourth exemplary communication configuration between the hand-held unit, the portable processing unit, and a sensor;

FIG. 5 is a perspective view of the system in which where the hand-held unit is secured to the portable processing unit; and

FIG. 6 is a flow chart illustrating an exemplary method of using the portable modular data collector and analyzer system.

### DETAILED DESCRIPTION

Various embodiments of a portable modular industrial data collector and analyzer system are provided that enable a user to collect and analyze data for a complex system or plethora of machinery as described below. The data collector and analyzer system may include two physically separate units that are configured to communicate with one another and/or with a sensor. The first unit may be a hand-held unit, a portable unit, or a display unit that includes a display and user interface. The hand-held unit may be an appropriately configured commercial off-the-shelf device, such as a personal digital assistant or other portable device that will typically include a display. The second unit may include a portable processing unit, an acquisition unit, or an ambulatory processing unit that includes a processor. The portable processing unit may include a portable computer, a personal digital assistant, a commercial off-the-shelf computing device, a custom computing device, or any other suitable computing device. Further, embodiments of the present invention enable an operator to proceed through a plant, from one machine location to another, collecting data on a plethora of machinery via completing a data collection route. Systems and methods for defining instrumented systems with with the invention may interact for such data collection enable a data collection are disclosed in U.S. Pat. No. 6,704,668, which is hereby incorporated into the present disclosure by reference.

The two units may include user mounts that facilitate transport of the units. Thus, as a way of reducing operator fatigue, heavier components and/or a majority of the components (or at least more bulky or heavy components) may be located in the unit that remains secured to the user (i.e., carried by but not hand-held) during operation and/or transport. For example, the heavier components may be positioned in the portable processing unit, which is then worn by the user (e.g., around his/her waist or on his/her back). The remaining components are then positioned in the hand-held unit, making this unit lighter and easier to handle. This system ensures that the operator not only gains increased portability but is also not required to sacrifice processing or analysis functionality. Additionally, the units are configured to allow for complete hands-free transport of the system via securing both units to the operator as a single unit or mounting them each individually.

The units may communicate with one another and/or with a sensor via wired or wireless connections. The first and second units may also communicate with other devices that are used to monitor a complex machine. For example, the units may communicate with a monitoring assembly, a host, a central monitoring station, a remote monitoring station, and/or other devices, as discussed in more detail below. As with the communication link between the two units, these communication links may include wireless or wired connections.

Wireless connection between the various elements, and particularly between the data collection components and sensors and transducers is advantageous because it reduces the possibility of entanglement of wires in moving components of the complex system. Additionally, wireless links may reduce the time to establish connections with the other devices because the units may be pre-programmed to automatically detect and establish these links with little or no user interaction. Further, a wireless connection enables communications with devices that may not be physically accessible. For example, transducers or sensors buried within housings or located near machine components that block direct access or where rotating components make wired connection unfeasible undesirable. Additionally, a wireless connection enables communications with devices that may be located in hazardous areas, such as areas that include explosive or toxic gases. Wireless connections may also reduce the time required to communicate with multiple sensors by eliminating the need for the operator to physically locate each individual sensor. This can reduce the time an operator has to remain in a noisy or otherwise hostile plant environment in order to acquire and analyze the data. Additionally, the unit may further make use of high speed data transmission and/or multiple channels to enable high data transfer rates between communication devices via a wireless link. Finally, although wireless links offer certain benefits, embodiments of the present invention may include wired connections to interface existing hardware. Therefore, as discussed in greater detail below, embodiments of the present invention may include a number of different communication configurations.

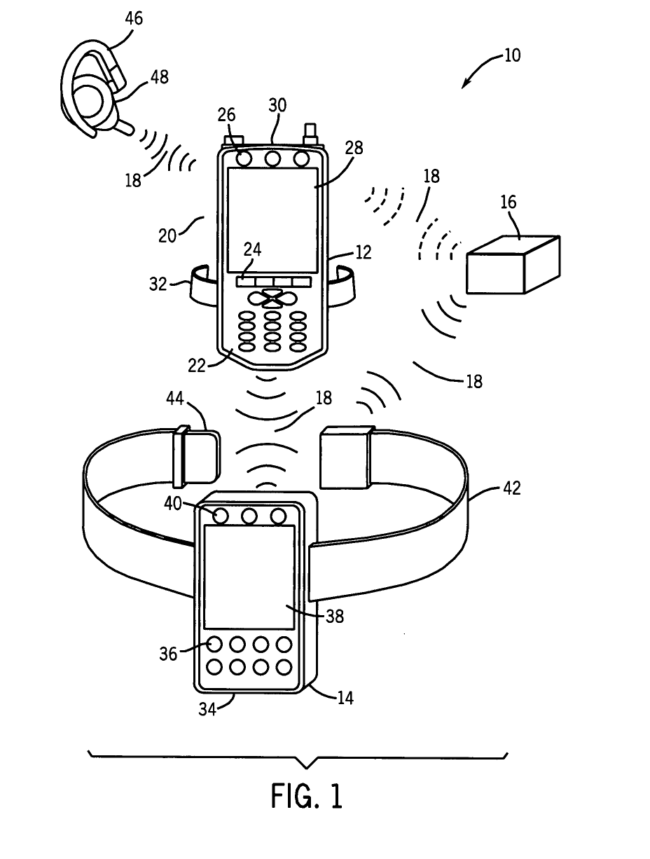

Turning now to the drawings, FIG. 1 illustrates exemplary elements of a portable modular data collector and analyzer system 10 in accordance with an exemplary embodiment of the invention. In one embodiment, system 10 includes a hand-held unit 12, a portable processing unit 14, and a sensor or transducer 16. Hand-held unit 12 may be referred to as a portable unit or a display unit and may be based on a commercial off-the-self platform, such as a programmed personal digital assistant (PDA) or other portable device. Portable processing unit 14 may be referred to as an acquisition unit or an ambulatory processing unit and may include a portable computer, or other computing device.

Hand-held unit 12, portable processing unit 14, and sensor 16 may be linked to one another via standard network media 18. Network media 18 may establish wired or wireless connections. The wired connection may take any suitable form and certain embodiments of the present invention may include a communications cable, a universal serial bus, a PC card, a serial port, a parallel port, or any other suitable wired connection. Additionally, the wireless connection may be made in accordance with any suitable wireless technique. For example, present wireless standards that satisfy the needs of the system might include ZigBee, IEEE 802.11, Bluetooth, IrDA (infrared light media) and so forth. Other technologies that are presently suitable, or that may soon be suitable include cellular telephony techniques. For distant communications, the techniques may include point hopping technologies, in which monitoring modules are scheduled to sleep and awaken to send and receive signals on a predetermined basis. Such techniques will allow for wireless communications at greater distances, and will also reduce the power required for driving the monitoring equipment and sensors.

As further illustrated in FIG. 1, hand-held unit 12 is physically separate from processing unit 14 and sensor 16. Hand-held unit 12 includes a housing 20 that is configured for easy transport (i.e., hand-held or mounted to the user). Hand-held unit 12 may also include a number of user interfaces and input keys. For example, the unit may include general input keys 22, functional input keys 24, or programmed input keys 26. General input keys 22 may provide for general or routine interaction with unit 12. For example, input keys 22 may include individual keys numbered “0” through “9”, arrow scroll keys, an “On/Off” key, as well as many others. Functional input keys 24 may include specific functions that are either pre-programmed or programmed by the user, thereby enabling the user to quickly access these functions. These keys may include labels such as “F1”, “F2”, etc. that are directly linked to the desired function. Where unit 12 is a conventional or specially programmed PDA, some or all of these may be integrated into a touch screen graphical user interface.

Hand-held unit 12 may further include a display 28 that may be VGA or other advanced standard encompassing various dimensional sizes. For example, display 28 may be ⅛ VGA (240×160 pixels), ¼ VGA (240×320 pixels), large VGA (5.4″×4″), or any other applicable size. Additionally, hand-held unit 12 may include a communication port 30 that enables the device to interface and communicate with other devices, such as transducer 16 or portable processing unit 14. In the illustrated embodiment, because data is transferred between the processing unit 14 and transducer 16, the wireless link 18 between the hand-held unit 12 and the transducer is shown in dashed lines. In practice, either unit may carry on communications with the transducer, although in general both may not need to do so.

Finally, hand-held unit 12 may include a user operator mount 32 that enables hands-free transport of the unit. In general, hands-free transport may be defined as both left and right hands being free from grasping the hand-held unit 12 or portable processing unit 14 during transport. Thus, user mount 32 may include a shoulder sling, a belt, a pouch, a plurality of straps, hook and loop fasteners, a pocket clip, or any other suitable mounting configuration.

Portable processing unit 14 includes a case 34 that is physically separate from hand-held unit housing 20. As with hand-held unit 12, portable processing unit 14 may also include a number of user input keys 36, a display 38, and communication ports 40. Additionally, portable processing unit may include a user mount 42 that also may include a locking mechanism 44. As with hand-held unit 12, user mount 42 enables hands-free transport of the unit via securing the unit to the operator. In certain embodiments described below, unit 14 is simplified, and primarily does processing and communications, off loading these functions from the more interactive “off-the-shelf” hand-held unit 12.

Finally, embodiments of the present invention may include various peripheral devices that are linked to either hand-held unit 12 or processing unit 14, or to both. Such peripheral devices may include a wireless headset 46 that includes a user mount, a microphone, and a speaker, as is generally indicated by numeral 48. The headset may further enable hands-free operation of the system by allowing the user to issue voice commands to hand-held unit 12 and/or processing unit 14. Additionally, the peripheral device may enable units 12 and 14 to provide audible feedback to the user in situations where the user can not view the display 28 (or 38), or may not be able to hear an audible alarm that is not in close proximity to their ear.

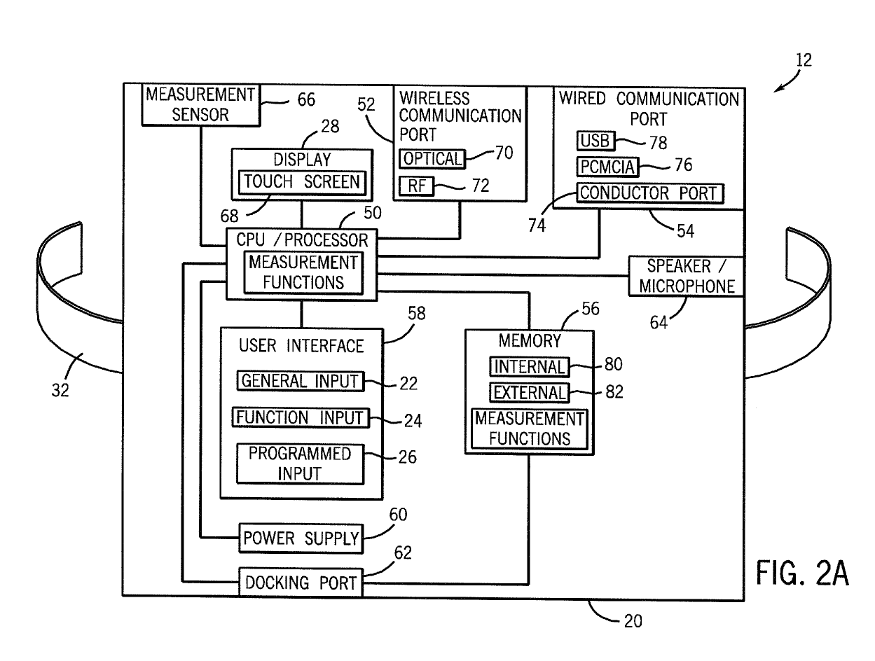

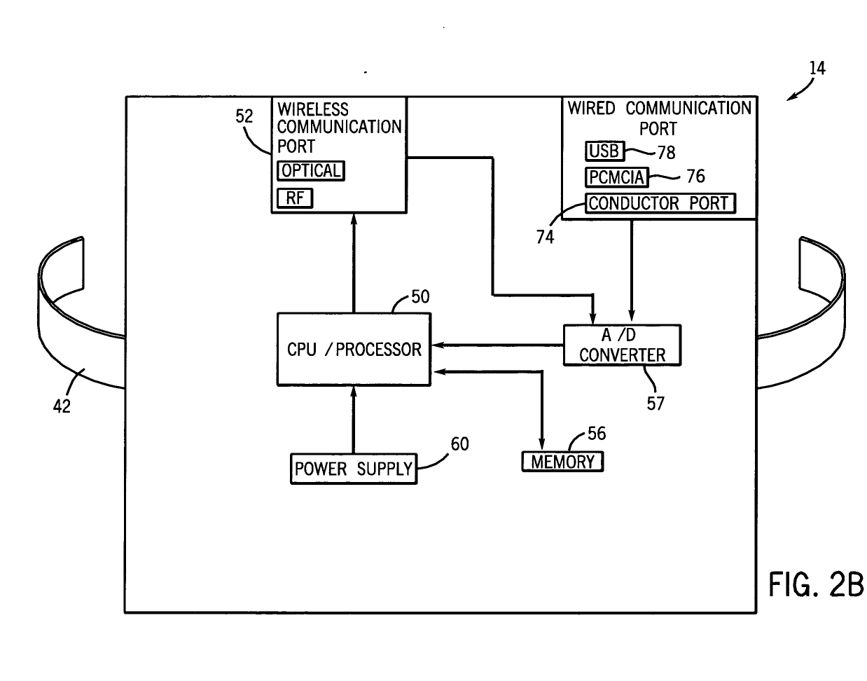

FIGS. 2A and 2B are diagrammatical representations of certain exemplary functional elements that may be included in hand-held unit 12 and portable processing unit 14, respectively. Specifically, FIG. 2A illustrates that hand-held unit 12 may include display 28, a CPU or processor 50, wireless communication port 52, a wired communication port 54, memory 56, user interface 58, power supply 60, docking port 62, speaker and microphone 64, and local measurement sensor 66. Display 28 may include a touch screen that works in conjunction with or in lieu of general input keys 22, function input keys 24, and programmed input keys 26. For example, a number of the function keys may also be included in the functionality of the touch screen. Additionally, user interface 58 may include devices such as additional keypads, a pointing device, a touch pad, a track ball, a pointing stick, a graphics tablet, a keyboard, or any other suitable user input device.

Power supply 60 may include a battery pack that interfaces the housing 20. The battery pack may include any type of rechargeable battery such as Ni-Cad or Lithium Ion. Additionally, non-rechargeable batteries may be used or the unit may include an electrical adapter to draw power from an external power source. Docking port 62 enables the unit to quickly interface other devices and may be used instead of wireless communication port 52 or wired communication port 54. Wireless communication port 52 may include an optical interface 70, a RF interface 72, or any other suitable wireless link. Similarly, wired communication port 54 may include a conductor port 74, a PCMCIA port 76, a universal serial bus port or ports 78, or any other suitable serial or parallel port. Additionally, integrated local measurement sensor 66 may include an optical tachometer, infrared temperature sensor, or any other suitable sensor. The local sensor enables the operator to detect such thing as speed and temperature without the need to carrying a physically separate individual sensor.

Memory 56 may include internal memory 80 or external memory 82. Internal memory 80 may include RAM, ROM, PROM, EPROM, EEPROM, FLASH, DRAM or any other volatile or non-volatile memory. External memory 82 may include an ATA Flash memory card, a SD memory card, or other suitable removable memory. Both internal memory 80 and external memory 82 may vary in capacity depending on the application. Further, the flexibility of external memory 82 enables the capacity of the memory to be tailored to the specific application. It should be noted that memory devices may be utilized that serve also as data transport mechanisms (i.e., that can be removed and used to transfer data to another device or system).

Finally, hand-held unit 12 may include CPU 50 that executes the processing and functionality of the device. For example, this functionality may include such things as spectral analysis, time waveform analysis, frequency response functions and so forth. Additionally, CPU 50 may include other functionality, such as a Bode/Nyquist plot functionality, Waterfall plot functionality, diagnostic functionality, and signal processing functionality. This functionality may be stored locally on the CPU 50 and/or on memory 56. As discussed above, all of these functional elements may be contained in housing 20 and mounted to the operator via a user mount 32 for hand-free transport. Once again, the system is not limited to the specific functional elements discussed. Moreover, the unit 12 may perform very limited calculations, with the portable processing unit 14 performing more complex computations, and then sending screen views to unit 12 for display.

As noted above, while many such functions can be performed by the hand-held unit, in a presently contemplated embodiment, more complex computations are performed by the portable unit 14, and communications with transducers are also originated by the portable unit. As illustrated diagrammatically in FIG. 2B, the portable unit may include many of the same elements, or the analog of elements found in the hand-held unit. For example, the portable unit may include wireless communication circuitry, designated generally by reference numeral 52, as well as wired communication circuitry 74, 76 and 78. Such circuitry permits communications between the portable unit and between the portable unit and the condition sensing transducers.

The portable unit also includes a CPU or processor 50 that is programmed via appropriate code stored in a memory circuit 56. A power supply 60 provides power for operation of the processor and other components of the portable unit. In general, many of the components of the portable unit may be similar to those of the hand-held unit, including those represented in FIG. 2A. However, depending upon the nature and intended use of the portable unit, components such as a separate display and user interface may not be optional or even eliminated. Moreover, in a presently contemplated embodiment, the portable unit may differ from the hand-held unit insomuch as the latter may be based on a commercial off-the-shelf offering, such as a PDA.

The portable unit will typically also include an analog-to-digital converter 57 that allows for conversion of raw data received from transducers to digital values that are applied to the processor 50. The processor 50 may perform computations and analyses based upon these values, and may store the raw or processed data in memory. Moreover, the processor may communicate data to the hand-held unit, and may receive inputs (e.g., commands, settings, and so forth) from the hand-held unit during data collection and subsequently.

Further, as discussed above, all of the functional elements for portable processing unit 14 may be contained in case 34 and mounted to the operator via user mount 38 enabling hands-free transport. Thus, embodiments of the present invention may be designed to reduce operator fatigue by locating the heavier elements in case 34 thereby reducing the weight of hand-held unit 12 without sacrificing the functionality of the system.

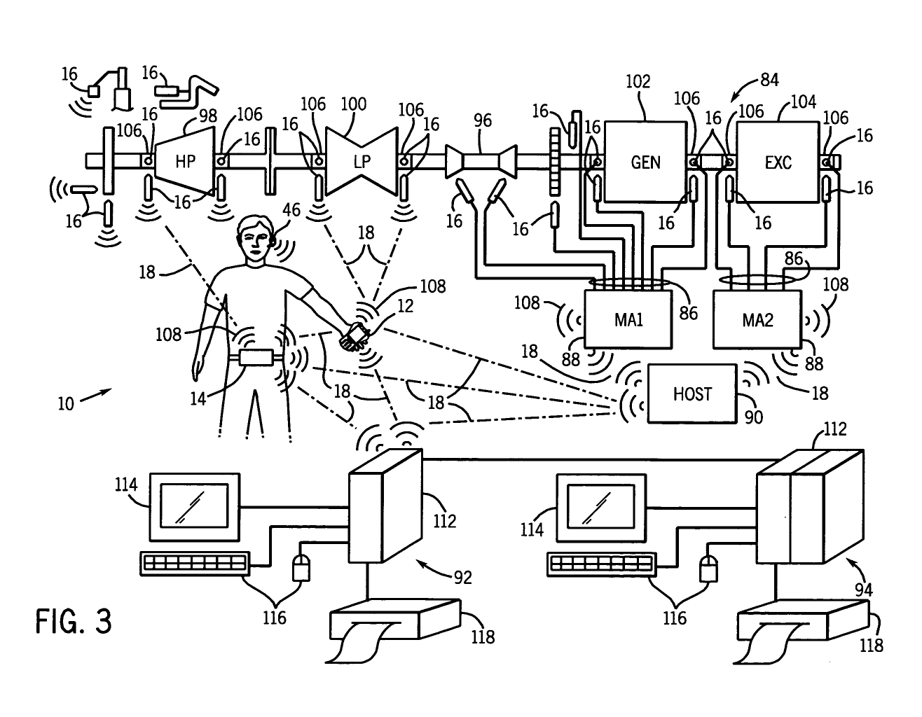

FIG. 3 is a diagrammatical overview of the portable modular data collector and analyzer system 10 applied to an exemplary machine system 84. System 10 is particularly well-suited for detecting, monitoring, and controlling a wide range of dynamic operating parameters of machine systems. In particular, the system is well-suited to various types of rotary equipment, although other applications may be envisaged for certain aspects of the present technique. As used herein, the term “dynamic operating condition,” or the reference to dynamic conditions in general, is intended to convey physical conditions or parameters of a machine system, as opposed, for example, to electrical conditions. The dynamic conditions may include such characteristics as vibration, rotation, speed, temperature, pressure, and so forth.

System 10 is designed to permit selective monitoring of dynamic operating conditions and parameters at various points along a machine system. In general, these points will correspond to locations at which such parameters can be sensed, and may be separated, independent or quite distal from one another. In the implementation illustrated in FIG. 3, for example, the mechanical system 84 generally represents a power generation system in which a wide range of dynamic operating conditions are monitored on a continual basis for informational and control purposes. Accordingly, system 10 includes sensors, detectors or transducers 16 mounted near or on various points of the machine system to detect the desired dynamic operating conditions. Transducers 16 may communicate to hand-held unit 12 and/or processing unit 14 via network media 18 that includes wireless or wired connections. Additionally, communication lines 86 may extend from the various transducers 16 to monitoring assemblies 88 that may also communicate with hand-held unit 12 and/or portable processing unit 14.

Monitoring assemblies 88 may be placed near the various monitored locations or points, and may, but need not be grouped. Certain of the monitoring assemblies, which will be described in greater detail below, may be linked via hosts 90. The hosts, or the monitoring assemblies directly, may be linked to central or remote monitoring stations 92 and 94 both within a plant or installation, or remote from the plant and installation. Typically, the monitoring assemblies 88 will be mounted closely adjacent to specific points or locations which are monitored, while hosts, if present, will be positioned near groups of monitors, or adjacent to a monitoring assembly. The central or remote monitoring station is typically provided in a desired plant location, such as a control room, for programming, monitoring, protection, and control functions. Additionally, hand-held unit 12 and portable processing unit 14 may be configured to communicate directly with host 90 and/or with remote monitoring stations 92 and 94.

In the exemplary mechanical system 84 illustrated in FIG. 3, rotary shafting 96 links a series of functional sections of the system, including a high pressure turbine section 98, a low pressure turbine section 100, a generator 102 and an exciter 104. As will be appreciated by those skilled in the art, the shafting and various components of the system are supported by a series of bearings 106. Other components may clearly be included in the system, although the representation of FIG. 3 has been intentionally simplified for explanatory purposes.

It should be noted that although a turbine system is illustrated as an example of one exemplary machine system with which the invention may be used, many other applications exist. Indeed, where a system is satisfactorily instrumented via resident condition sensors, the portable system of the invention may not be required. However, for specific monitored points and on certain types of systems and machines, many monitoring points may exist that are not permanently instrumented. Such systems may include, for example, paper making machines, steel and other metal rolling lines, and fans, to mention only a very few. Thus, the present technique may be applied in a wide range of industrial settings, including to material handling applications, production equipment, assembly stations and lines, and so forth. It should also be noted that the present data collection technique need not be used in conjunction with machine systems that are otherwise permanently instrumented for collection of similar data. However, where existing sensors are available, these may represent an opportunity for data collection via the portable system of the invention. Again, however, the portable system of the invention may prove most useful in situations where no permanent monitoring is performed.

The various sensors and transducers 16 of system 10 may produce a wide range of signals based upon the detected dynamic operating conditions. Each generates one or more signals which may be applied to hand-held unit 12 and portable processing unit 14 via network media 18. Additionally, the signals may be applied to monitors within each monitoring assembly 88 via the communication lines 86. The various transducers may be active or passive, and may receive power for operation via the communication lines or from a local or external power source. By way of example, sensors and transducers 16 of the instrumented system of FIG. 3 may detect dynamic operating conditions such as valve position and case expansion, as indicated diagrammatically to the upper left in FIG. 3, eccentricity, bearing absolute casing vibration, both in X and Y directions, differential expansion, speed of rotation, rotational phase, and so forth. As will be noted by those skilled in the art, various sensors and transducers may be employed for these purposes, including linear variable differential transformers, non-contact pickups, rotary potentiometers, accelerometers, and so forth. Indeed, in a present implementation, the particular configuration of monitors within the monitoring assemblies includes a specially adapted vibration monitor designed to be coupled to a tachometer and to an accelerometer. Such accelerometers may detect, for example, signals indicative of shaft, casing or pedestal vibration, depending upon the application.

Thus, hand-held unit 12, portable processing unit 14, and monitoring assemblies 88 generally serve to receive, process, report and act upon the signals supplied by sensors and transducers 16. For example, specific monitors within the assemblies may process input signals to produce vibration data which is used to analyze the performance or operating conditions of the mechanical system. Where desired, and as described more fully below, specific processing of this type may be implemented via the hand-held unit 12, portable processing unit 14, and/or monitoring assemblies 88, and closed-loop operation of the equipment may be provided, such as to energize or de-energize the components or a single component of the system. As will be appreciated by those skilled in the art, certain of the monitored dynamic operating conditions may be particularly indicative of abnormal and unwanted conditions, such as wear, impending failure, unbalance, excessive loading, and so forth. Also as described more fully below, certain of the monitors within the monitoring assemblies may be designed to energize or de-energize an internal or external relay or similar switch to permit rapid control functions.

In addition to processing and analysis, hand-held unit 12, portable processing unit 14, and monitoring assemblies 88 may generally provide outputs for external devices as indicated at reference numeral 108 in FIG. 3. The outputs may include electrical signals which can be applied to dedicated components, such as motors, alarms, lights, valves, and so forth. These outputs are generated based upon the monitoring and analysis functions performed by the monitoring modules and, depending upon the programming of the various modules, with input from remote devices such as the other monitoring assembly modules or a central or remote monitoring station.

Those skilled in the art will recognize that the topology afforded by the present technique presents distinct advantages in terms of the physical media employed to connect the various components of the system. For example, hand-held unit 12 and/or portable processing unit 14 may communicate directly with transducers 16 or may communicate with monitoring assemblies 88 and/or host 90 local to specific points via a wired or wireless connection. Thus, system 10 enables an operator to quickly interface a fixed topology via monitoring assemblies 88 and host 90 while providing for a flexible topology via hand-held unit 12 and portable processing unit 14.

The various centralized or remote monitoring stations 92 and 94 may include any suitable equipment, such as general purpose or application-specific computers 112, monitors 114, interface devices 116, and output devices 118. Although simple computer systems are illustrated diagrammatically in FIG. 3, those skilled in the art will recognize that the centralized or remote monitoring stations may include highly complex analytical equipment, logging equipment, operator interface stations, control rooms, control centers, and so forth. As noted above, while at least one such monitoring station will typically be provided at or near the application, other stations may be provided entirely remote from the application, such as for monitoring plants, lines, production equipment, offshore facilities, and the like from entirely remote access points.

Once again, hand-held unit 12 and/or portable processing unit 14 may be in direct communications with monitoring station 92 and 94. Thus, units 12 and 14 may quickly access historical logs or data for a machine system 84 via this communication link. Additionally, units 12 and 14 may transmit collected and analyzed data to or from the monitoring station 92 and 94 for historical logs. In many implementations, on the contrary, it may be advantageous for units 12 and 14 to function completely autonomously from monitoring stations. Data may be collected by a technician, and provided at a later time to a monitoring system in raw, partially processed or fully processed formats. Such later data delivery may be performed by any suitable uplink technique, including wired and wireless connections, conventional industrial or Internet protocols, and so forth. Additionally, certain embodiments may permit the exchange of alarms, limits, and so forth.

As mentioned above, a present implementation of the techniques and monitoring module designs discussed herein accommodates analysis of vibrational data. Such vibrational data may be a key component in mechanical system monitoring and control. In a present implementation, vibrational profiles are generated in dedicated vibration monitors based upon multiple channels of signal acquisition, from accelerometers and tachometers. The circuitry and processing capability within the vibration monitors performs any suitable analysis to generate vibrational data, which may be presented as a vibration profile. Alarm or alert ranges, limits, levels, and the like may be established and combined with the vibrational data for monitoring and control functions both within the monitoring module and in conjunction with other monitoring modules and control devices.

An exemplary vibrational profile may take the form of a two axis plot that includes a frequency range on the x-axis and a vibration magnitude on the y-axis. Additionally, the plot may include certain vibration bands and alarm levels. For example, the frequencies may be divided into desired bands, such as by reference to actual operating frequencies of the equipment. That is, bands may be established for analysis purposes which are divided at any convenient point over a range of frequencies of interest (including overlapping or spaced apart bands. The actual vibration profile may extend across the bands and will typically exhibit a range of magnitudes depending upon the nature and characteristics of the machine system. For example, a typical rotating machine system will exhibit certain natural frequencies which result in elevated magnitudes of vibration reaching peaks.

The alarm limits discussed above may have several interesting and particularly useful characteristics. Firstly, different alarm levels may be set for different frequency bands, the limits of which may also be set, so as to allow for the specific tailoring of the monitoring functions to individual systems based upon their typical or desired frequency response. Moreover, multiple alarm levels may be set by an operator for each frequency band and for the multiple frequency bands. Accordingly, the alarm levels may be configured so to define ranges such as minimum and maximum vibration levels. The configurations also permit the alarm levels to be used in various manners. By way of example, attaining certain alarm levels may result in reporting only, while attaining more elevated alarm levels may result in sounding or displaying an alarm, or in energization or de-energization of a relay circuit so as to start or stop a piece of machinery. The rapid analysis of vibrational data in this manner, for example, may be used to start or stop electric motors, switch valves, illuminate lights, sound audible alarms, and so forth. In certain embodiments, system 10 may collect and download data to a host system. The host system may then compare the data to alarm limits and remotely notify the operator of an alarm threshold violation, thereby enabling the operator to take immediate action.

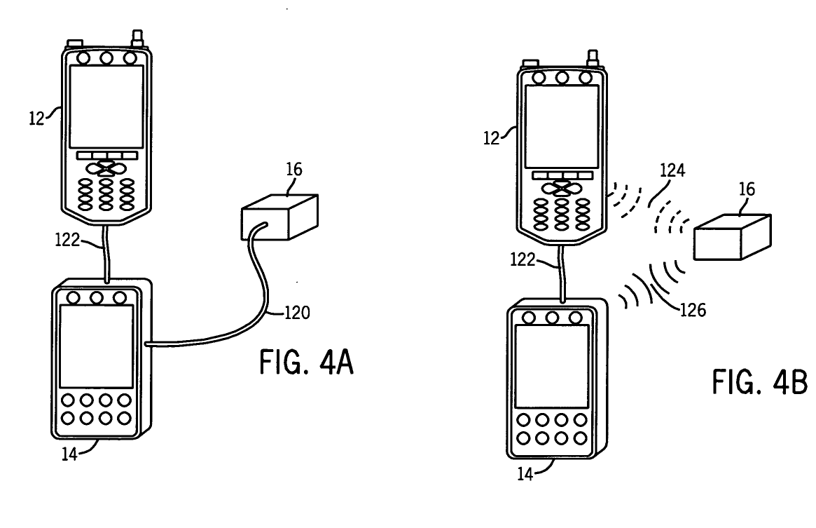

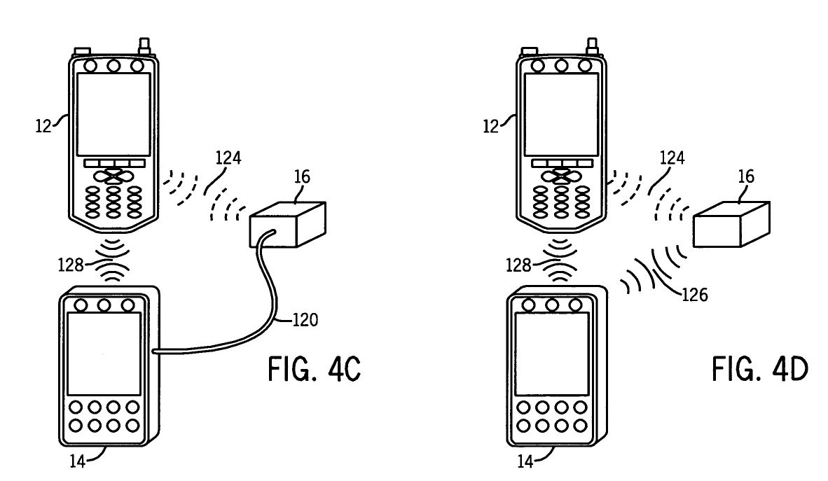

FIGS. 4A-4D illustrate exemplary communication configurations between hand-held unit 12, portable processing unit 14, and transducer 16. FIG. 4A illustrates a wired connection 120 between portable processing unit 14 and transducer 16 and a wired connection 122 between hand-held unit 12 and portable processing unit 14. As discussed above, the wired link may be enabled via a conductor cable port, a universal serial bus port, a PC card interface, a serial port, a parallel port, or any other suitable port.

FIGS. 4B-4D illustrate various other exemplary communication configurations that include a wireless connection 126 between transducer 16 and portable processing unit 14, and a wireless connection 128 between portable processing unit 14 and hand-held unit 12. As discussed above, a wireless connection offers a number of advantages, but embodiments of the present invention are not limited to wireless links. Further, embodiments of the present invention are not limited to any specific configuration and may include a combination of a number of the communication configurations illustrated within one application. For example, hand-held unit 12 or portable processing unit 14 may be connected to one transducer via a wired connection while at the same time connected to a second transducer via a wireless connection. Also, as discussed above, one or both units 12 and 14 may communicate with the transducers (e.g., see the dashed wireless links 124 in FIGS. 2B-2D).

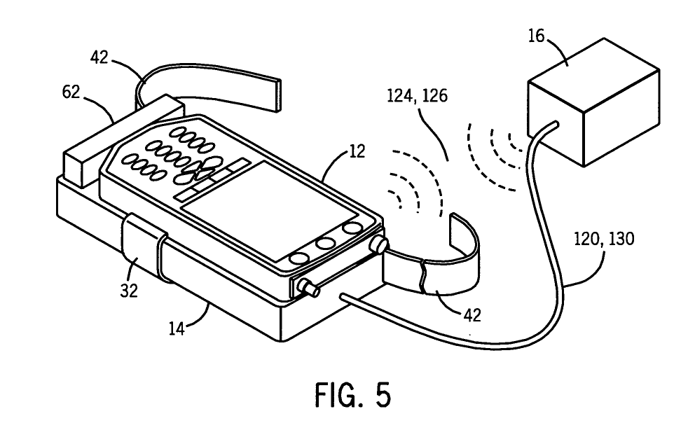

FIG. 5 is a perspective view of the system illustrating hand-held unit 12 secured to portable processing unit 14. This configuration may simplify hands-free transport by securing both units to the user via a single user mount 42. Additionally, hand-held unit 12 may communicate with the portable processing unit 14 via the docking port 62, wired communication link 122, or wireless communication link 128. Hand-held unit 12 and/or processing unit 14 may also communicate with transducer 16 via a separate or shared wired connection 120 and 130 and/or wireless connection 124 and 126.

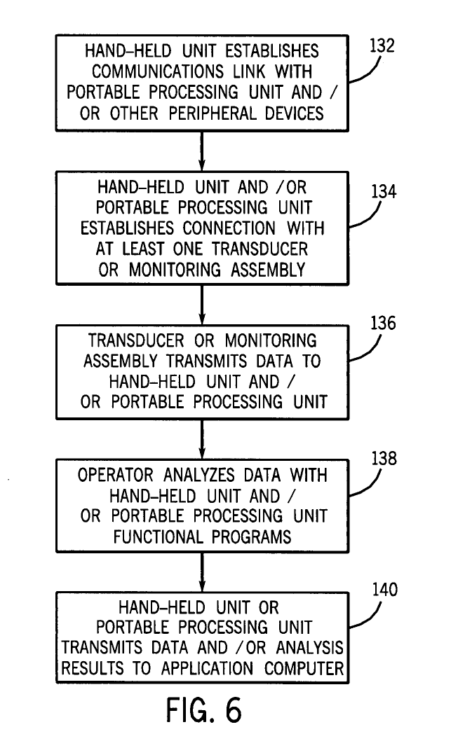

FIG. 6 is a flow chart illustrating an exemplary method of using certain embodiments of system 10. The process is initiated by hand-held unit 12 establishing a communication link with portable processing unit 14 and possibly a peripheral device 46 (block 132). As discussed above, this communication may be a wired connection or a wireless connection and may take the form of any suitable link between such devices. Additionally, the communications link may be established by docking the hand-held unit onto the portable processing unit.

Next, either portable processing unit 14 or hand-held unit 12 establishes a communications link with a transducer or a plurality of transducers (block 134). Additionally, units 12 and 14 may establish a communications link with a monitoring assembly 88 during this step or thereafter. As discussed above, monitoring assembly 88 may generally serve to receive, process, report and act upon the signals supplied by one transducer or a plurality of transducers. In other words, monitoring assemblies 88 may serve as a master node for a plurality of slave nodes (i.e., transducers) thereby enabling the operator to quickly and remotely interface with a network via this communication link. Moreover, the monitoring assemblies may communicate with a host 90 that may serve as a master node for a plurality of other monitoring assemblies. Thus, the user is enabled to remotely interface a plurality of transducers and the data generated by the transducer via a single gateway. Additionally, hand-held unit 12 and/or portable processing unit 14 may be configured to communicate directly with multiple transducers without having to establish a link with monitoring assembly 88 or host 90.

After the desired communication links have been established, the transducer or monitoring system transmits the data to hand-held unit 12 or portable processing unit 14 (block 136). The data may include real-time raw data, historical raw data, real-time pre-processed data, historical pre-processed data, real-time processed data, historical processed data, or any other related data, such as maintenance logs, transducer identification, technician logs, etc. “Real-time” may be defined as exhibiting no time lag or a relatively small time lag, with the amount of time lag being determined by the given application. Historical data may be defined as data that is not real-time. Raw data may include a pure signal output such as voltage or current measurements in an analog device, data digitized from analog measurements, or an unfiltered digital signal in digital devices. Additionally, pre-processed data may include filtered data or data that has been converted from analog to digital form or vice versa. Processed data may include data that has been analyzed and reduced to a specific format to simplify the review process, or that is the result of calculations performed on raw or pre-processed data. For example, historical processed data might include a previously generated Bode plot.

Next, the operator may process or analyze the data using the hand-held unit and portable processing unit (block 138). This enables the user to analyze and trouble-shoot possible problems in real-time. For example, the operator may use a pre-programmed function in the hand-held and/or portable processing unit to quickly process a large amount of raw data. Thus, the operator is able to address problems and take corrective action from locations, such as during “walk arounds”. Additionally, the user may simply collect the data from one or many different monitoring points, then relocate to a remote position to process the data, or upload the data to a separate device or system for further processing, storage and analysis. This is especially useful in situations where it is unsafe for the user to remain in close proximity to the transducer, but also requires some visual confirmation.

Again, because the system includes a hand-held unit and a portable processing unit, the weight of the components can be distributed to increase portability and reduce operator fatigue without sacrificing system functionality. Finally, the processed data may then be transmitted to an application computer for further processing or stored for maintenance records (block 140).

While only certain features of the invention been illustrated and described herein, many modifications and changes will occur to those skilled in the art. It is, therefore, to be understood that the appended claims are intended to cover all such modifications and changes as fall within the true spirit of the invention.

1. A system for monitoring dynamic operating conditions of a machine system, comprising:
a portable processing unit comprising a processor and configured to communicate with a physically separate sensor that detects a dynamic operating condition of a machine system; and
a hand-held unit comprising a display and a user interface, the hand-held unit being physically separate from but in data communication with the portable processing unit to enable a user to analyze data generated by the sensor, wherein the data originates from the sensor physically separate from both the portable processing unit and the hand-held unit.

2. The system of claim 1, wherein the portable processing unit communicates with the physically separate sensor via a wireless connection.

3. The system of claim 1, wherein the portable processing unit communicates with the physically separate sensor via a wired connection.

4. The system of claim 1, wherein the portable processing unit communicates with the hand-held unit via a wireless connection.

5. The system of claim 1, wherein the portable processing unit communicates with the hand-held unit via a wired connection.

6. The system of claim 1, wherein the portable processing unit includes a user mount to enable hands-free transport of the portable processing unit.

7. The system of claim 6, wherein the user mount comprises a shoulder sling, a belt, a pouch, a plurality of straps, hook and loop fasteners, a pocket clip, or combination thereof

8. The system of claim 1, wherein the user interface comprises a keypad, a touch screen, a pointing device, a touch pad, a track ball, a pointing stick, a graphics tablet, a keyboard, or a combination thereof.

9. The system of claim 1, wherein the hand-held unit comprises a personal digital assistant or other portable device comprising a display and user interface.

10. The system of claim 1, comprising a peripheral device configured to communicate with the hand-held unit via a wireless connection, the peripheral device further comprising a microphone to enable a user to issue voice commands to the hand-held unit and audio output to enable a user to receive audible signals indicative of machinery operating condition feedback from the hand-held unit.

11. The system of claim 1, wherein the portable processing unit comprises a display, a user input device, a power supply, an integrated sensor, a wireless communications port, a wired communications port, a speaker, a microphone, an internal memory, an external memory interface, or a combination thereof.

12. The system of claim 1, wherein the portable processing unit comprises personal digital assistant, commercial off-the-shelf computing device, custom computing device, or a portable computer.

13. A system for monitoring dynamic operating conditions of a machine system, comprising:
an acquisition unit comprising a processor and configured to communicate with a physically separate plurality of sensors; and
a portable unit comprising a display and a user interface, the portable unit being physically separate from but in communications with the acquisition unit to enable an operator to process and analyze data generated by the plurality of sensors, wherein the data originates from the plurality of sensors physically separate from both the acquisition unit and the portable unit.

14. The system of claim 13, comprising a physically separate plurality of sensors configured to detect dynamic operating conditions of a machine system.

15. The system of claim 13, wherein the acquisition unit communicates with a physically separate plurality of sensors via a wireless connection.

16. The system of claim 13, wherein the acquisition unit communicates with a physically separate plurality of sensors via a wired connection.

17. The system of claim 13, wherein the acquisition unit communicates with the portable unit via a wireless connection.

18. The system of claim 13, wherein the acquisition unit communicates with the portable unit via a wired connection.

19. The system of claim 13, comprising a central monitoring station configured to communicate with the acquisition unit, the portable unit, the physically separate plurality of sensors or a combination thereof.

20. The system of claim 13, wherein the acquisition unit and the portable unit comprise operator mounts to enable hands-free transport.

21. A system for monitoring dynamic operating conditions of a machine system, comprising:
a mobile processing unit comprising a processor with memory or storage, the mobile processing unit being physically separate from but in communications with a display unit comprising a display and a user interface, the mobile processing unit or the display unit in communications with a physically separate plurality of sensors and configured to analyze data generated by the plurality of sensors, wherein the data originates from the plurality of sensors physically separate from both the mobile processing unit and the display unit.

22. The system of claim 21, wherein the mobile processing unit communicates with the physically separate plurality of sensors via a wireless connection.

23. The system of claim 21, wherein the mobile processing unit communicates with the physically separate plurality of sensors via a wired connection.

24. The system of claim 21, wherein the mobile processing unit communicates with the display unit via a wireless connection.

25. The system of claim 21, wherein the mobile processing unit communicates with the display unit via a wired connection.

26. The system of claim 21, wherein the display unit communicates directly with the physically separate plurality of sensors via a wireless connection.

27. The system of claim 21, wherein the display unit communicates directly with the physically separate plurality of sensors via a wired connection.

28. The system of claim 21, comprising the mobile processing unit and the display unit in communication with the physically separate plurality of sensors and configured to analyze data from the plurality of sensors.
